(19) United States
(12) Patent Application Publication
(10) Pub. No.: US 2014/0240177 A1
(43) Pub. Date: Aug. 28, 2014

(54) Antenna Device and Wireless Communication Device

(71) Applicant: Wistron NeWeb Corporation, Hsinchu (TW)

(72) Inventors: Chih-Ming Wang, Hsinchu (TW); Chung-Hung Chen, Hsinchu (TW); Shih-Chiang Wei, Hsinchu (TW); Kai-Yang Cheng, Hsinchu (TW); Ming-Feng Chang, Hsinchu (TW)

(21) Appl. No.: 13/909,026

(22) Filed: Jun. 3, 2013

(30) Foreign Application Priority Data
Feb. 27, 2013 (TW) 102107048

(51) Int. Cl. H01Q 1/22; H01Q 13/10

(52) U.S. Cl. CPC H01Q 1/2266; H01Q 13/10
USPC 343/702; 343/767

(57) ABSTRACT

An antenna device for a wireless communication device is disclosed. The antenna device includes a metal plate including a radiating element formed with at least a slot structure and a feed-in terminal and a grounding element, and a connecting unit electrically connected between the grounding element and a system grounding unit of the wireless communication device.

### BACKGROUND OF THE INVENTION

1. Field of the Invention

The present invention relates to an antenna device and a wireless communication device, and more particularly, to an antenna device and a wireless communication device capable of directly grounding current, so as to reduce an area of the antenna device.

2. Description of the Prior Art

Portable electronic products with wireless communication functionalities, e.g., laptops, tablet PCs, etc., utilize antennas to emit and receive radio waves for transmitting or exchanging radio signals, so as to access wireless network. With the increasing demand for the appearance and functionalities of portable electronic products, available space for each component in a portable electronic product is getting compressed, so is the available space for an antenna device.

For example, FIG. 1 is a schematic diagram of a conventional laptop 10. The laptop 10 comprises a chassis 100 and a lid 102, wherein a mainframe is disposed in the chassis 100, and a liquid crystal display (LCD) screen is included in the lid 102. The chassis 100 and the lid 102 are connected by a roller 104, which comprises a hinge cap 106 and hinges 108, 110, such that the lid 102 can be folded and unfolded or rotated in relation to the chassis 100. In general, an antenna of the laptop 10 may be disposed in the chassis 100 or the lid 102. However, because of the demand for a thin and light laptop 10, the available space of the chassis 100 or the lid 102 is restricted. Moreover, a shell of the chassis 100 or the lid 102 may be covered with a metal material, which may affect the antenna efficiency. Therefore, the industry has provided a concept of disposing the antenna of the laptop 10 in the roller mechanism 104. However, since the space of the roller mechanism 104 is still limited, it is a common goal in the industry to design an antenna which fits for the limited space.

### SUMMARY OF THE INVENTION

It is therefore an objective of the present invention to provide an antenna device and a wireless communication device capable of effectively reducing the required area for disposing the antenna.

An embodiment of the present invention discloses a slot antenna device for a wireless communication device, comprising a metal plate, including a radiating portion and a grounding portion, wherein the radiating portion has at least one slot structure and a feed-in terminal; and a connecting element, electrically connecting the grounding portion and a system grounding element of the wireless communication device.

An embodiment of the present invention further discloses a wireless communication device, comprising a lid; a chassis; a system grounding element, disposed on the lid or the chassis; a roller mechanism, connected with the lid and the chassis such that the lid is capable of rotating in relation to the chassis; a slot antenna device, comprising a metal plate, including a radiating portion and a grounding portion, wherein the radiating portion has at least one slot structure and a feed-in terminal; and a connecting element, electrically connecting the grounding portion and the lid or the system grounding element inside the chassis.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a conventional laptop.

FIGS. 2A, 2B and 2C are schematic diagrams of assembly, lateral view and exploded view of an antenna device according to an embodiment of the present invention, respectively.

FIG. 2D is a schematic diagram of a metal plate shown in FIG. 2A after flattened.

FIGS. 3A, 3B, and 3C are schematic diagrams of assembly, lateral view and exploded view of an antenna device according to an embodiment of the present invention, respectively.

FIG. 4 is an exploded-view diagram of an antenna device according to an embodiment of the present invention.

FIG. 5 is a schematic diagram of voltage standing wave ratio (VSWR) of the antenna device shown in FIG. 2A.

FIG. 6A is a schematic diagram of a metal plate according to an embodiment of the present invention.

FIG. 6B is a schematic diagram of VSWR when the metal plate shown in FIG. 6A is applied to the antenna device shown in FIG. 2A.

FIG. 7A is a schematic diagram of an antenna component according to an embodiment of the present invention.

FIG. 7B is a schematic diagram of VSWR when the antenna component shown in FIG. 7A is applied to the antenna device shown in FIG. 2A.

FIG. 8A is a schematic diagram of an antenna component according to an embodiment of the present invention.

FIG. 8B is a schematic diagram of VSWR when the antenna component shown in FIG. 8A is applied to the antenna device shown in FIG. 2A.

FIG. 9A is a schematic diagram of an antenna component according to an embodiment of the present invention.

FIG. 9B is a schematic diagram of VSWR when the antenna component shown in FIG. 9A is applied to the antenna device shown in FIG. 2A.

### DETAILED DESCRIPTION

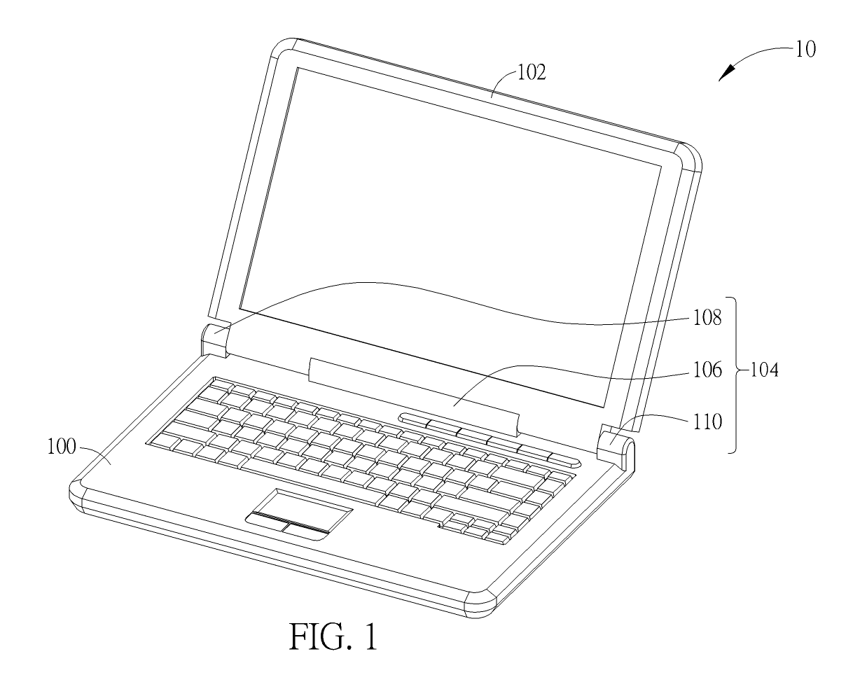

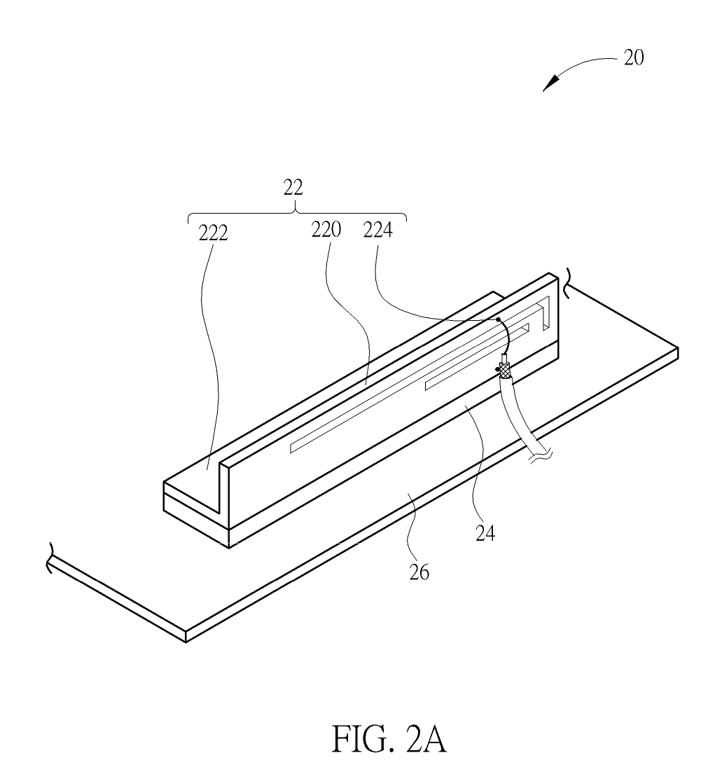

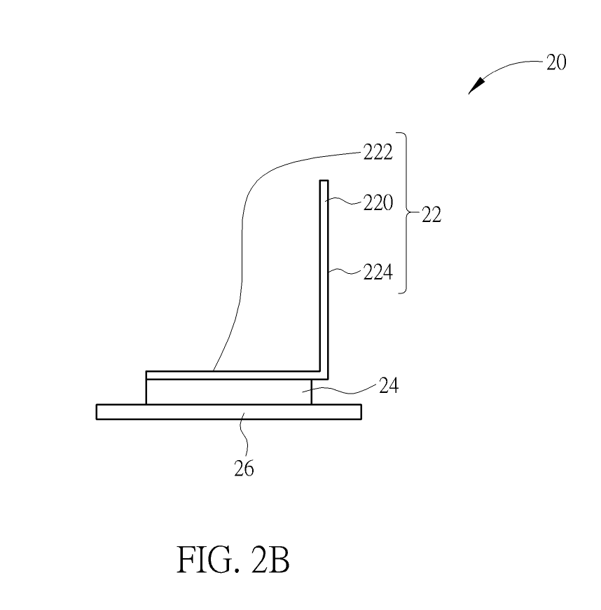

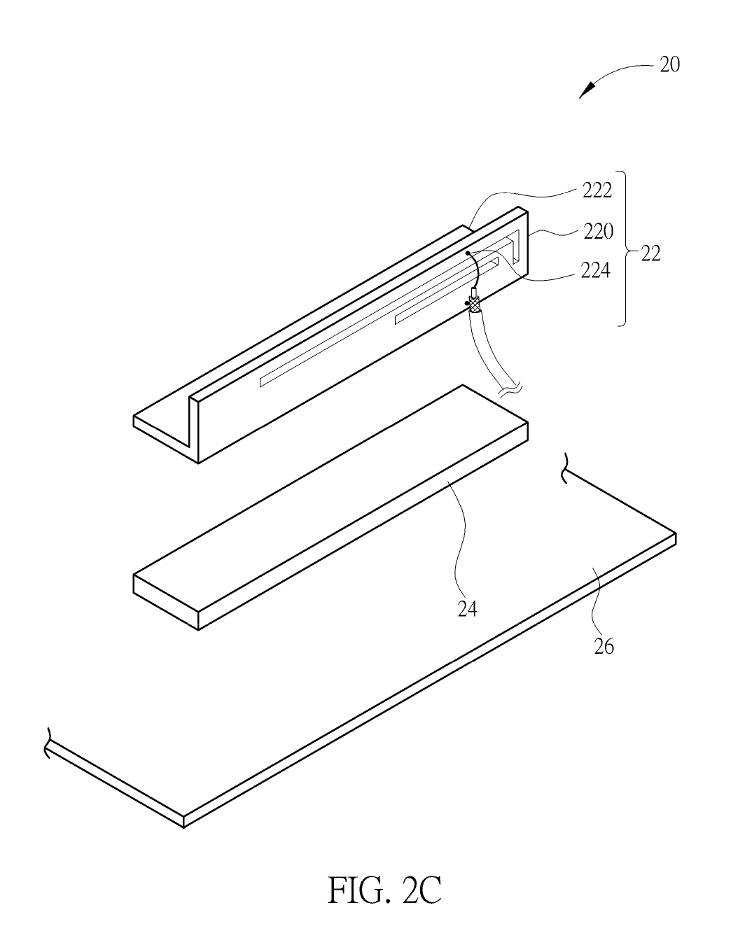

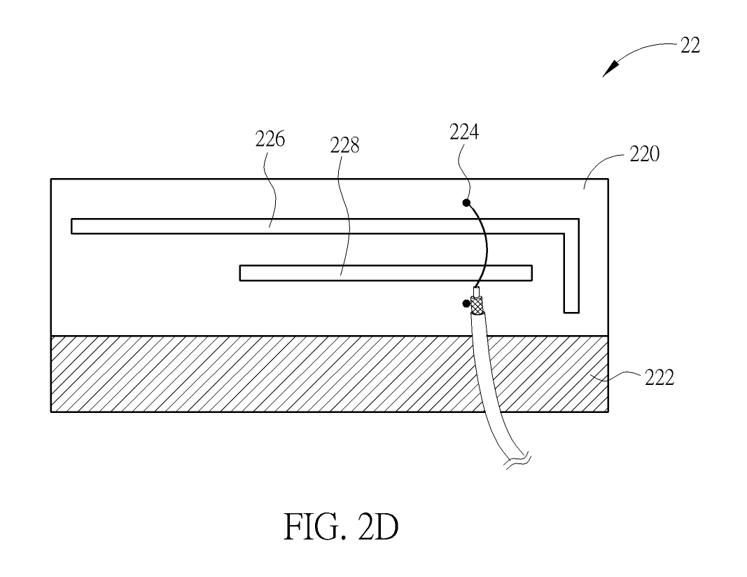

Please refer to FIGS. 2A, 2B and 2C, which are schematic diagrams of assembly, lateral view and exploded view of a slot antenna device 20 according to an embodiment of the present invention, respectively. The slot antenna device 20 is used in a wireless communication device, and may be disposed in a roller mechanism of the wireless communication device. Taking the laptop 10 shown in FIG. 1 as an example, the slot antenna device 20 may be disposed in the hinge cap 106 or hinges 108, 110 of the roller mechanism 104, but is not limited thereto. The slot antenna device 20 comprises a metal plate 22 and a connecting element 24, and is used for transmitting and receiving radio signals of two different frequency bands, such as 2.4 GHz and 5 GHz. Please refer to FIG. 2D for an elaborated structure of the metal plate 22. FIG. 2D is a schematic diagram of the metal plate 22 being flattened. The metal plate 22 includes a radiating portion 220 and a grounding portion 222, wherein a feed-in terminal 224 is formed on the radiating portion 220 for transmitting and receiving radio signals. In the embodiment, slots 226, 228 are formed on the radiating portion 220 by means of etching or drilling. Lengths of the slots 226, 228 are substantially equal to a half wavelength of radio signals at the transmitting and receiving bands. In other words, the radiating portion 220 is a dual-band slot antenna. Besides, the connecting element 24 is used for electrically connecting the grounding portion 222 and a system grounding element 26 of the wireless communication device. As a result, an area required for disposing the radiating portion 220 is effectively reduced.

In detail, if the slot antenna device 20 is applied to the laptop 10 shown in FIG. 1, the system grounding element 26 may be a grounding structure (or a ground plate) of an liquid crystal display (LCD) screen in the lid 102, which can provide a good grounding effect. Furthermore, the connecting element 24 electrically connects the grounding portion 222 and the system grounding element 26, which enhances the grounding effect of current on the radiating portion 220, so as to reduce the area required for disposing the radiating portion 220. Taking the frequency band around 2.4 GHz as an example, a conventional half-wavelength slot antenna requires 65 to 70 mm in length in order to resonate at 2.4 GHz. In comparison, under the same condition, a slot antenna (such as the slot 226) can be reduced to around 50 mm in length by using the slot antenna device 20. Therefore, the embodiment of the present invention is capable of effectively reducing the required area for disposing an antenna. Note that the above-mentioned system grounding element 26, which is a grounding structure (or a ground plate) of the LCD screen in the lid 102, is an example of the present invention. The system grounding element 26 may also be a grounding structure of other device in the lid 102 or a specific device in the chassis 100, such as a grounding portion of the mainframe in the chassis 100. The system grounding element 26 is not limited herein, and may be realized in various forms as long as it provides the system grounding effect.

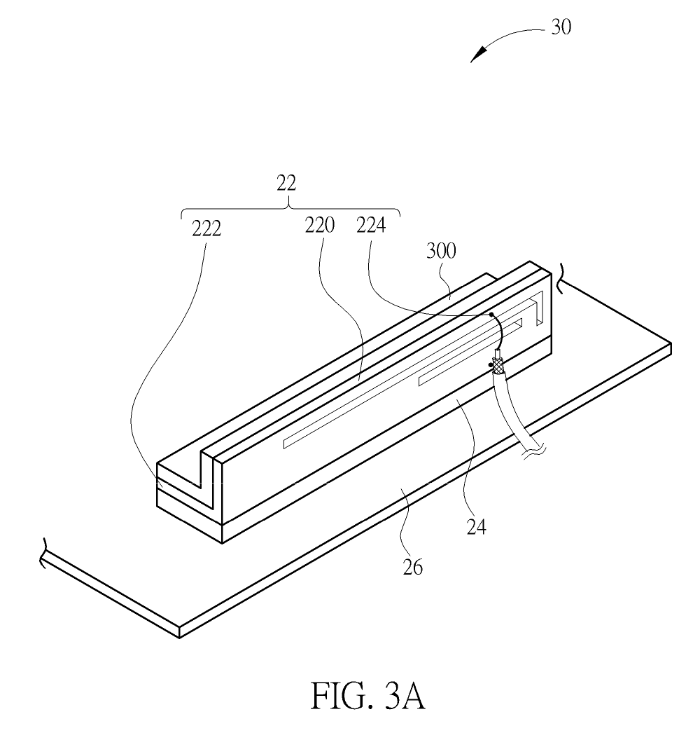

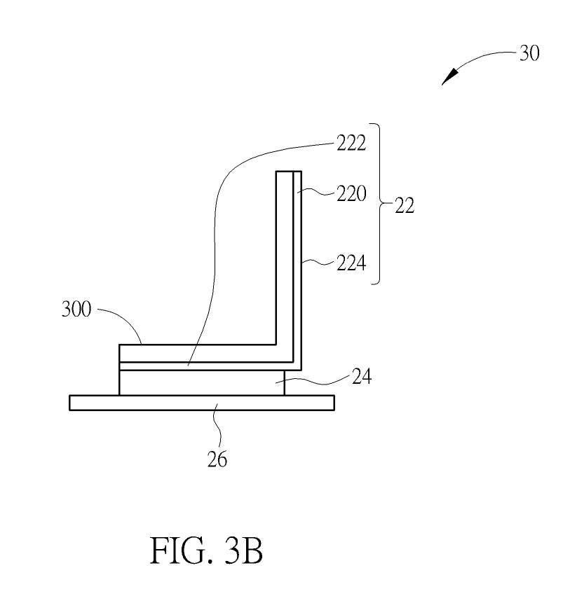

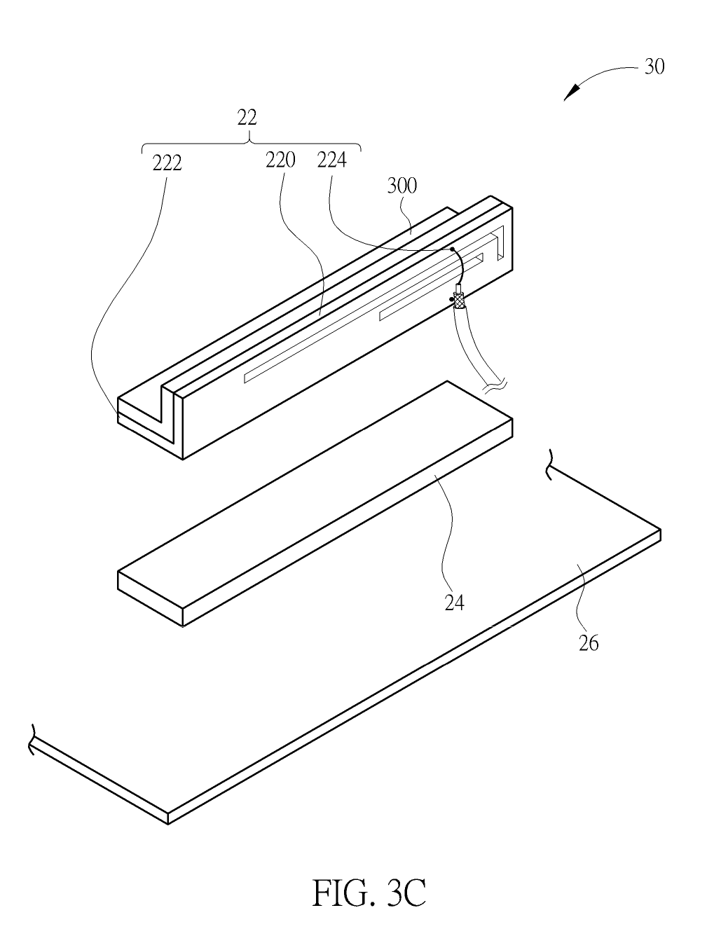

The slot antenna device 20 shown in FIG. 2A to 2D is an embodiment of the present invention, and those skilled in the art can make alterations and modifications accordingly. For example, in the metal plate 22, an included angle is formed between the radiating portion 220 and the grounding portion 222, which is to match with an emitting angle or a mechanism design. The included angle is not restricted to a specific value, and may be any value as long as the radiating portion 220 and the grounding portion 222 are distinguishable. Moreover, the metal plate 22 may be any metal material, such as iron or copper, and the metal plate 22 may be formed on a substrate or a non-conductive supporting element. For example, please refer to FIGS. 3A, 3B and 3C, which are schematic diagrams of assembly, lateral view and exploded view of an antenna device 30 according to an embodiment of the present invention, respectively. As can be seen by comparing FIGS. 3A, 3B, 3C with FIGS. 2A, 2B, 2C, the structures of the slot antenna device 30 and the slot antenna device 20 are identical, so the same symbols denote the same elements. A difference between the slot antenna device 30 and the slot antenna device 20 is that the metal plate 22 in the slot antenna device 30 is formed on a non-conductive supporting element 300 by means of sticking, laser engraving, or etching.

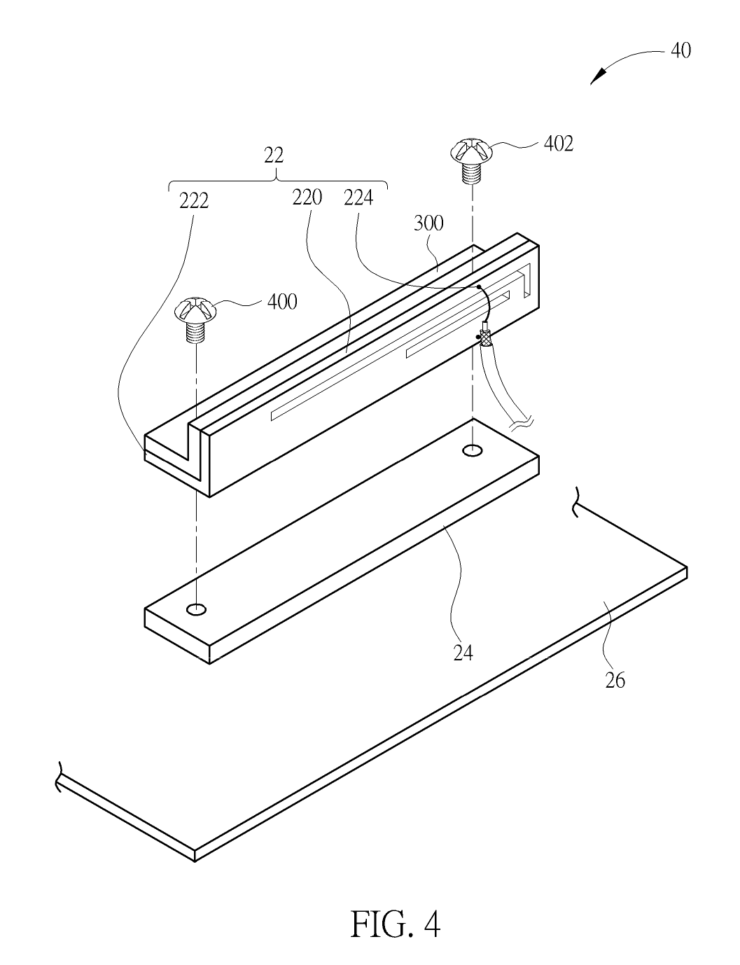

In the slot antenna device 20 or 30, the connecting element 24 may be made of a conductive cushioning material, a conductive metal, or a composite material thereof for entirely attaching the grounding portion 222 and being closely fixed to the system grounding element 26. The conductive cushioning material may be conductive foam, conductive sponge, conductive fabric, etc., and the conductive metal may be copper foil, aluminum foil, sheet iron, solder, etc., but are not limited thereto. In addition, the connecting element 24 may also be composed of multiple connecting units. Furthermore, the slot antenna device 20 or 30 may include a fixing element for fixing relative positions of the connecting element 24, the grounding portion 222 and the system grounding element 26. For example, FIG. 4 is an exploded-view diagram of an antenna device 40 according to an embodiment of the present invention. As can be seen by comparing FIG. 3C and FIG. 4, the structures of the slot antenna device 40 and the slot antenna device 30 are identical, so the same symbols denote the same elements. A difference between the slot antenna device 40 and the slot antenna device 30 is that the slot antenna device 40 further includes screws 400, 402, which fasten the grounding portion 222 and the connecting element 24 on the system grounding element 26 for stable fabrication. The screws 400, 402 are fasteners for locking the connecting element 24, the grounding portion 222 and the system grounding element 26. In addition to screws, the fasteners may be realized by hooks, leaf springs or nuts, and are not limited thereto.

Besides, in the slot antenna device 30 and the slot antenna device 40, the grounding portion 222 is located between the non-conductive supporting element 300 and the connecting element 24, i.e., the metal plate 22 is disposed under the non-conductive supporting element 300. Besides, the metal plate 22 may also be disposed upon the non-conductive supporting element 300 while the non-conductive supporting element 300 is located between the grounding portion 222 and the connecting element 24. In such a case, vias or other connecting elements are required to connect the grounding portion 222 and the connecting element 24, which is an alteration by referring the above-mentioned embodiments and should be known to those skilled in the art.

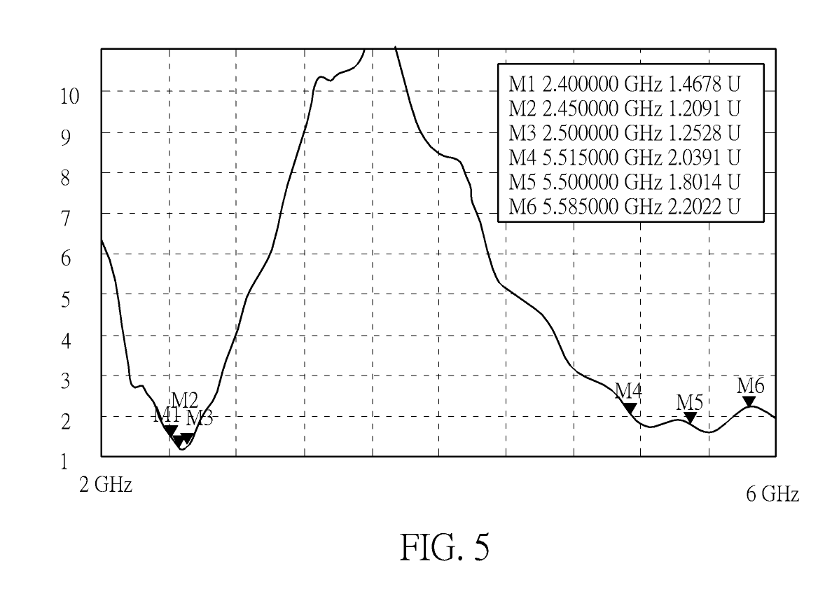

The main differences of the slot antenna devices 20, 30, and 40 is that the non-conductive supporting element 300 is added to the slot antenna device 30, and the screws 400, 402 are further added to the slot antenna device 40. Except these differences, the rest parts of the slot antenna devices 30 and 40 are identical to the slot antenna device 20, and therefore, the slot antenna devices 20, 30, and 40 have the same radiation effect. For example, by tuning the lengths of the slots 226, 228 in the slot antenna device 20, a diagram of voltage standing wave ratio (VSWR) shown in FIG. 5 can be obtained. As can be seen from FIG. 5, the slot antenna device 20 can achieve a dual-band radiation effect.

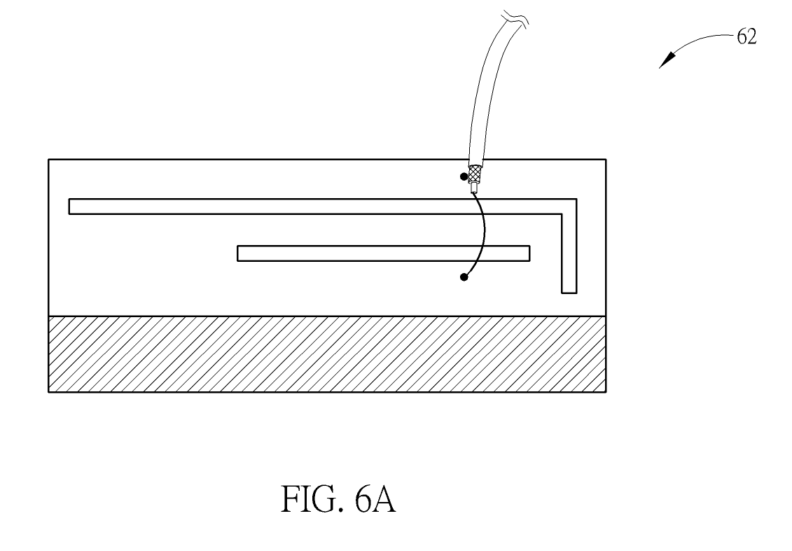

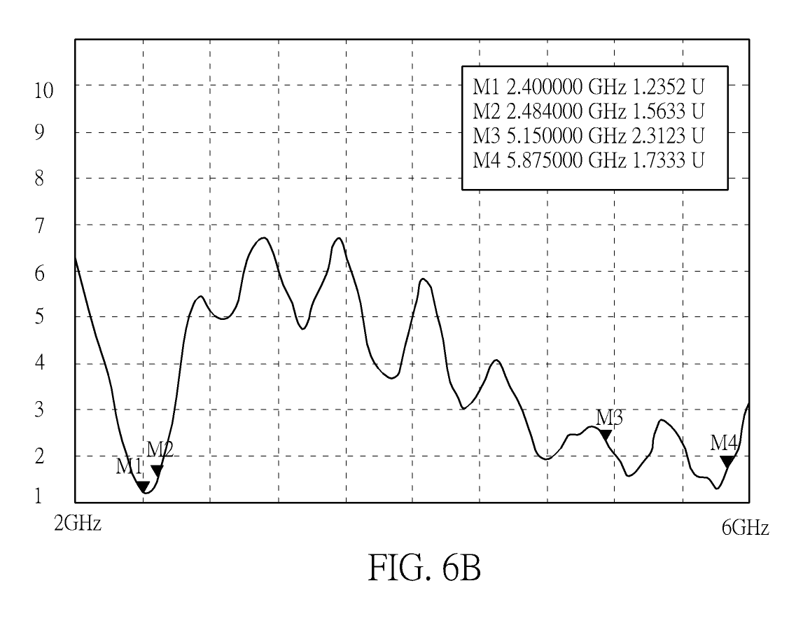

In the embodiments mentioned above, the radiating portion 220 of the metal plate 22 includes double slots 226, 228, and the feed-in direction is from the shorter slot 228 to the longer slot 226, i.e., from bottom to top, which however, is not limited thereto. Other forms of radiating portion or feed-in methods may be applied to the present invention. For example, FIG. 6A illustrates a schematic diagram of a metal plate 62 according to an embodiment of the present invention. The structure of the metal plate 62 is the same as that of the metal plate 22 in the slot antenna devices 20, 30 and 40, and thus the metal plate 62 can replace the metal plate 22 for the slot antenna devices 20, 30 and 40. A difference between the metal plate 62 and the metal plate 22 is that the feed-in direction in the radiating portion of the metal plate 62 is opposite to that in the slot antenna device 20/30/40. In such a situation, the corresponding VSWR diagram is shown as FIG. 6B.

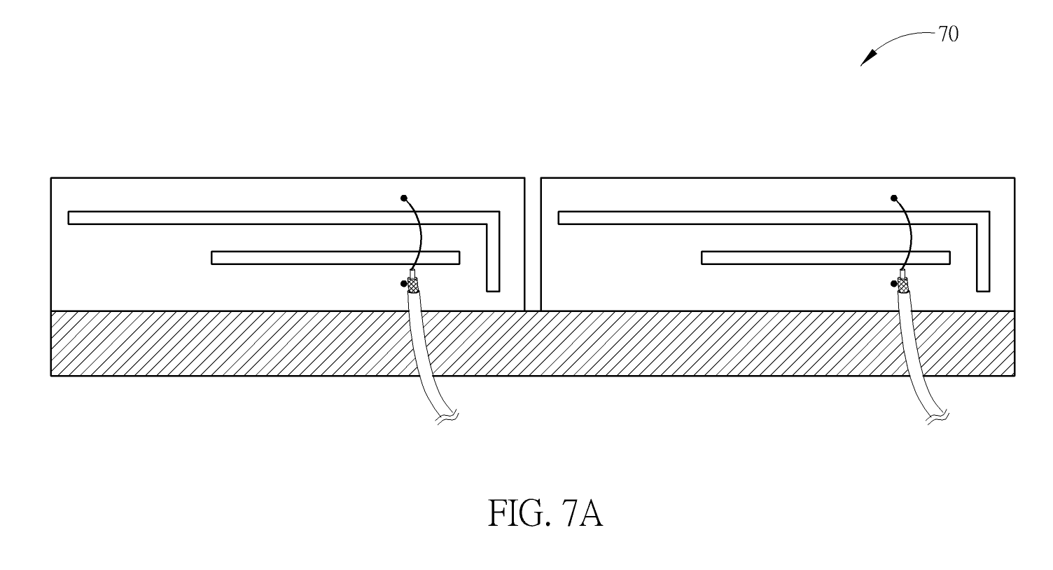

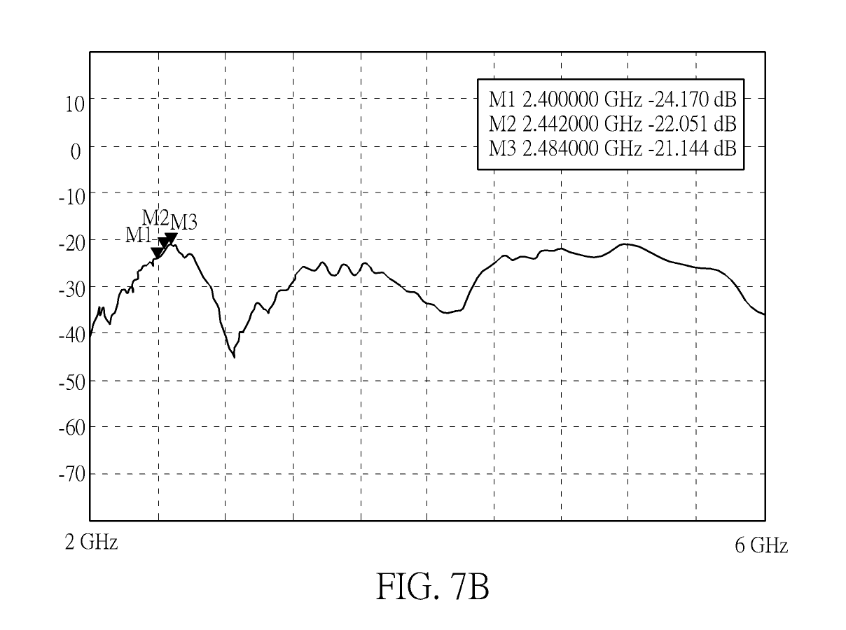

In addition to using single metal plate 22 or 62 for transmitting and receiving radio signals, two (or more) metal plates 22, 62 disposed side by side may be used for Multi-Input Multi-Output (MIMO) applications if space permits, or other feed-in methods may be further adopted for the present invention. For example, FIG. 7A illustrates a schematic diagram of an antenna component 70 according to an embodiment of the present invention. As can be seen by comparing FIG. 7A with FIG. 2D, the antenna component 70 is composed of two metal plates 22 disposed side by side, and may replace the metal plate 22 in the slot antenna devices 20, 30 and 40. Certainly, when applying the antenna component 70 to the slot antenna devices 20, 30 and 40, the lengths and areas of the elements thereof, such as the connecting element 24, need to be adaptively modified. In such a situation, isolation of two slot antennas in the antenna component 70 is shown as FIG. 7B.

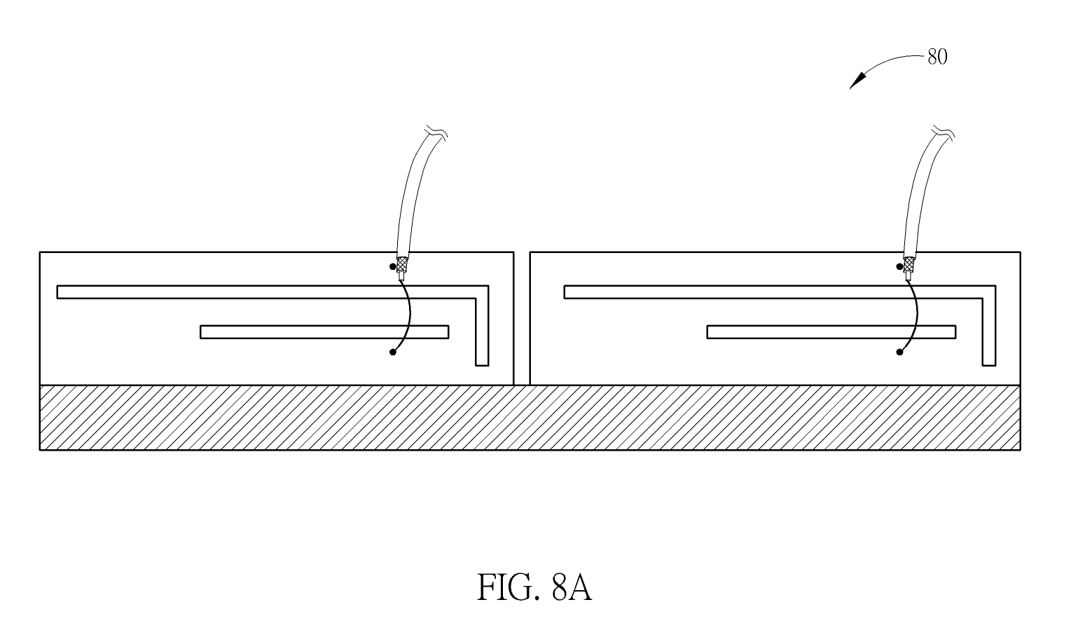

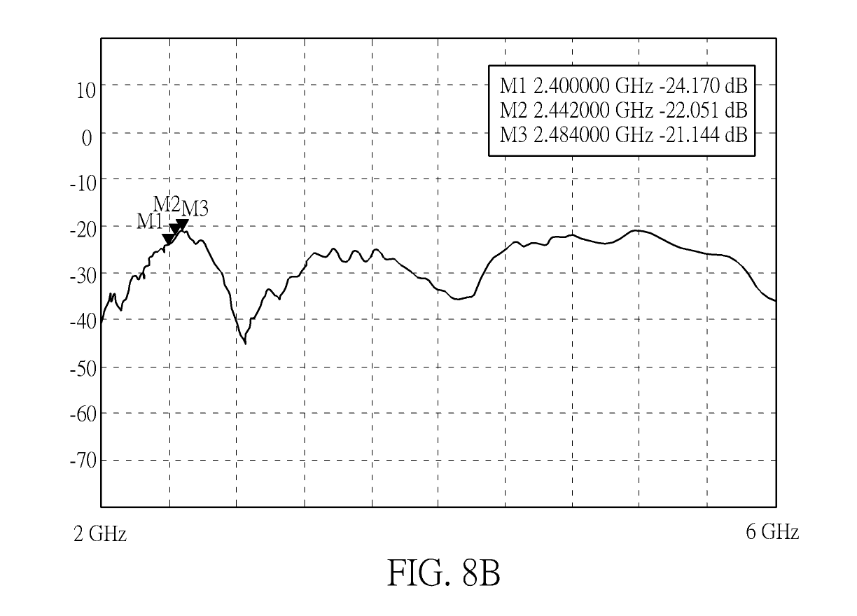

Similarly, please refer to FIG. 8A, which illustrates a schematic diagram of an antenna component 80 according to an embodiment of the present invention. As can be seen by comparing FIG. 8A with FIG. 6A, the antenna component 80 comprises two metal plates 62 disposed side by side, and may also replace the metal plate 22 in the slot antenna devices 20, 30 and 40. Certainly, when applying the antenna component 80 to the slot antenna devices 20, 30 and 40, the lengths and areas of the elements thereof, such as the connecting element 24, need to be adaptively modified. In such a situation, isolation of two slot antennas in the antenna component 80 is shown as FIG. 8B.

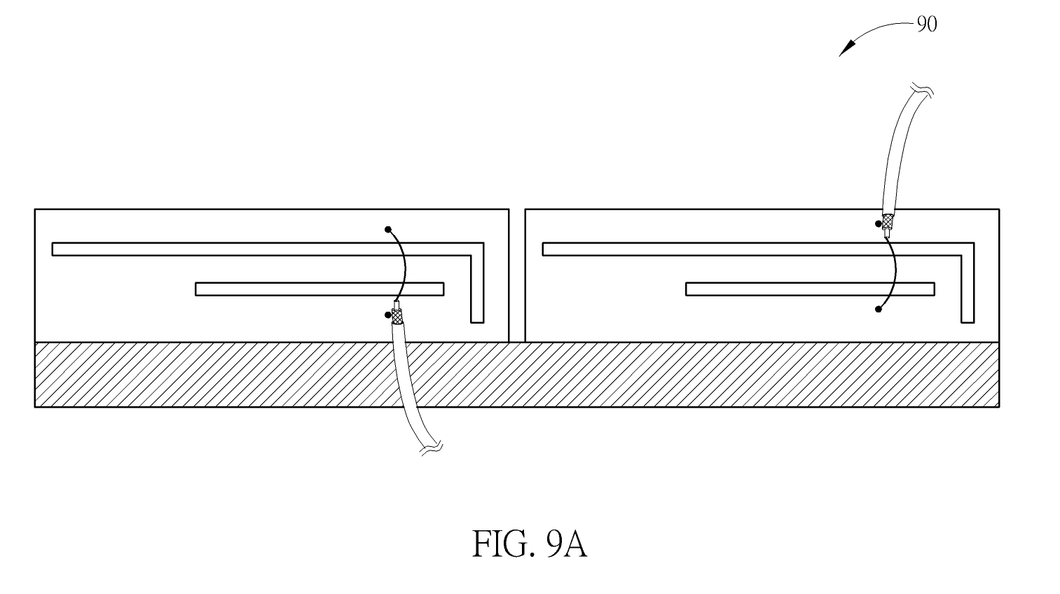

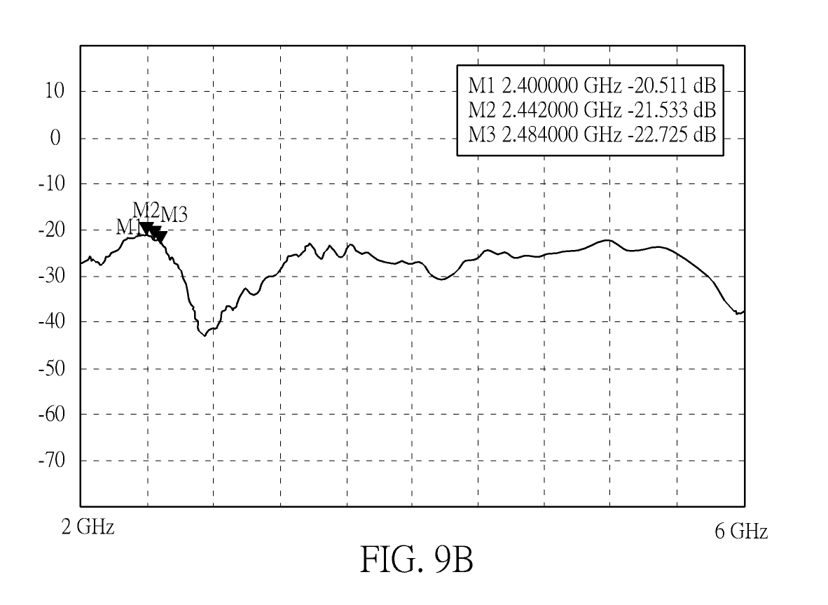

Moreover, please refer to FIG. 9A, which illustrates a schematic diagram of an antenna component 90 according to an embodiment of the present invention. As can be seen by comparing FIG. 9A with FIG. 2D and FIG. 6A, the antenna component 90 comprises plates 22 and 62 disposed side by side, and may also replace the metal plate 22 in the slot antenna devices 20, 30 and 40. Certainly, when applying the antenna component 90 to the slot antenna devices 20, 30 and 40, the lengths and areas of the elements thereof, such as the connecting element 24, need to be adaptively modified. In such a situation, isolation of two slot antennas in the antenna component 90 is shown as FIG. 9B.

As can be seen by comparing FIG. 9B with FIG. 7B and FIG. 8B, the antenna component 90 has better isolation. Please further refer to U.S. patent application Ser. No. 13/760,072 for the concept pertaining to the isolation of antenna components.

Furthermore, as mentioned previously, the slot antenna device 20 (or 30, 40) may be disposed on the hinge cap 106 or hinges 108, 110 in the roller mechanism 104 of the laptop 10, and the disposition method is not restricted. For example, in an embodiment, the slot antenna device 20 may be movable along with the lid 102, i.e., when the lid 102 rotates in relation to the chassis 100 by a external force, the slot antenna device 20 may also rotate in relation to the chassis 100. In another embodiment, the slot antenna device 20 may not be movable along with the lid 102, i.e., when the lid 102 rotates in relation to the chassis 100 by an external force, the slot antenna device 20 may maintain the same position relative to the chassis 100 instead of rotating along with the lid 102.

To sum up, the present invention is capable of enhancing a grounding effect of current on the radiating portion of the antenna device by electrically connecting the grounding portion and the system grounding element of the antenna device via the connecting element. Therefore, the area required for disposing the radiating portion can be reduced. In such a situation, the antenna device of the present invention is suitable for being disposed in limited space, such as a roller mechanism of a laptop, in order to comply with the appearance requirement of the portable electronic product.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A slot antenna device for a wireless communication device, comprising:
a metal plate, comprising a radiating portion and a grounding portion, wherein the radiating portion has at least one slot structure and a feed-in terminal; and
a connecting element, electrically connecting the grounding portion and a system grounding element of the wireless communication device.

2. The slot antenna device of claim 1, further comprising a non-conductive supporting element, on which the metal plate is formed.

3. The slot antenna device of claim 1, further comprising a fixing element, for fixing the relative positions of the connecting element, the grounding portion and the system grounding element.

4. The slot antenna device of claim 3, wherein the fixing element comprises at least one screw, for locking the connecting element, the grounding portion and the system grounding element.

5. The slot antenna device of claim 1, wherein the connecting element is made of a conductive cushioning material or a conductive metal.

6. The slot antenna device of claim 1, wherein the wireless communication device comprises a liquid crystal display (LCD) screen, and a grounding structure of the LCD screen comprises the system grounding element.

7. A wireless communication device, comprising:
a lid;
a chassis;
a system grounding element, disposed on the lid or the chassis;
a roller mechanism, connected with the lid and the chassis such that the lid is capable of rotating in relation to the chassis;
a slot antenna device, comprising:
a metal plate, comprising a radiating portion and a grounding portion, wherein the radiating portion has at least one slot structure and a feed-in terminal; and
a connecting element, electrically connecting the grounding portion and the lid or the system grounding element inside the chassis.

8. The wireless communication device of claim 7, wherein the slot antenna device further comprises a non-conductive supporting element, on which the metal plate is formed.

9. The wireless communication device of claim 7, wherein the slot antenna device further comprises a fixing element, for fixing the relative positions of the connecting element, the grounding portion and the system grounding element.

10. The wireless communication device of claim 9, wherein the fixing element comprises at least one screw, for locking the connecting element, the grounding portion and the system grounding element.

11. The wireless communication device of claim 7, wherein the connecting element is made of a conductive cushioning material or a conductive metal.

12. The wireless communication device of claim 7, wherein the slot antenna device moves in response to movement of the lid and rotates in relation to the chassis when the lid is rotated in relation to the chassis by an external force.

13. The wireless communication device of claim 7, wherein the slot antenna device does not move in response to movement of the lid and maintains the same position in relation to the chassis when the lid is rotated in relation to the chassis by an external force.

14. The wireless communication device of claim 7, wherein the lid comprises a liquid crystal display (LCD) screen, and a grounding structure of the LCD screen comprises the system grounding element.
